(19) United States
(12) Patent Application Publication
(10) Pub. No.: US 2008/0240986 A1
(43) Pub. Date: Oct. 2, 2008

(54) Assaying device for collecting, storing, and testing fluid samples

(76) Inventor: Shungho Chang, San Diego, CA (US)

Correspondence Address: Jay Y. Chiu, 16148 Sand Canyon Avenue, Irvine, CA, 92618, US

(21) Appl. No.: 11/900,562

(22) Filed: Sep. 11, 2007

(30) Foreign Application Priority Data
Mar. 30, 2007 (DE) 202007004797.5

(51) Int. Cl. B01J 19/00

(52) U.S. Cl. 422/68.1

(57) ABSTRACT

An assaying device for collecting, storing, and assaying fluid samples includes a container and a cap. Disposed within the cap is a chamber for housing an assay testing system. A flow channel is provided for communicating between the container and the testing system and enabling the fluid samples to be introduced to the testing system from the container upon change of orientations of the device. A tamper-proof flow control valve and a key are provided for regulating the flow of the fluid sample in the flow channel, thereby, the assaying can be activated only when desired by an authorized person with the key.

### CROSS-REFERENCE TO RELATED APPLICATIONS

This application claims the benefit of priority under 35 U.S. Code §119 of German Patent Application Number 202007004797.5, filed on Mar. 30, 2007 by the present inventor.

### FEDERALLY SPONSORED RESEARCH

None

### SEQUENCE LISTING OR PROGRAM

None

### FIELD OF THE INVENTION

The present invention generally relates to an assaying device and more specifically relates to assay devices for testing the presence of chemical or hormonal constituents in fluid samples, such as human urine.

### BACKGROUND OF THE INVENTION

To achieve minimal handling of the fluid samples by a technician during an in-field screening and testing process, prior arts have developed convenient in-field assaying devices where fluid collection containers and assay testing systems were integrated into a single unit, and a flow channel in the unit communicates between the container and the testing system enabling the fluid samples to be introduced to the testing system from the container, such as upon a change of orientation of the container, eliminating the need for the technician to pipette the fluid samples from a collection container into a separate device that houses the testing system.

Generally, the testing systems for an in-field screening and testing process utilize test results that manifest chromatographic test results for ease of observing the results in the fields. The assay runs automatically once the fluid samples are introduced to the testing systems. As it would be appreciated by those skilled in the art, the ability to control the exact lapse of time of the test is required in order to ascertain accurate readings of a chromatographic test result. However, sometimes, this ability is frustrated by the fluid samples' donors, because following the collection of the fluid samples, the donors can, accidentally or intentionally, introduce the fluid samples into the testing systems and do not relinquish the assaying device to the technicians after substantial time has been elapsed, and in which case, the technicians have no way of ascertaining the exact lapse of time for the test in order to obtain an accurate test result. As such, it is highly desirable to have a tamper-proof in-field assaying device where the testing system can only be activated by a technician, and cannot be activated by a donor; thus, the technician can measure the accurate lapse of time of the test.

The present invention provides a tamper-proof regulator in the flow channel of the device that can seal and unseal the testing system from the fluid sample collection container by a specifically designed key, whereby a person without the key, such as the donor, cannot unseal the testing system from the fluid samples and activate the assaying.

Still further objects and advantages will become apparent from a consideration of the ensuing description and drawings.

### SUMMARY OF INVENTION

The present invention is an assay device for collection of fluid samples and testing chemical or hormonal constituents in the fluid samples. The assay device generally includes a container for collecting the fluid samples and a cap for sealing the container. A testing chamber having an assay testing system is disposed in the cap. An opening is also disposed in the cap between the testing chamber and the container defines a flow channel for the fluid samples to be introduced to the testing chamber. The testing system preferably comprises at least one test strip element having reagents suitable for chemical or immunological reaction with specific detecting substances, such as marijuana metabolites or phenocyclidine (PCP) and capable of manifesting chromatographic results.

A flow control valve is disposed in the flow channel as a regulator for the flow channel, so that when the flow control valve is closed, the flow channel is sealed and no fluid samples can flow from the container to the testing chamber or vice versa. The device is tamper-proof in that the flow control valve can be opened or closed only with a specifically designed key.

If the assaying were not performed immediately following the collection of the fluid samples, later during the assaying, a negative pressure created by the cooling of warm sample fluids in a sealed container can interfere with the flow of the fluid samples into the testing chamber. The device in accordance with the present invention therefore further includes an air flow path, or an air vent, disposed in the cap for enabling ambient air to flow into the container, and the ingress of the ambient air can equalize any negative pressure that was formed in the container due to the cooling of the fluid samples. Furthermore, in the device in accordance with the present invention, a vent control valve is disposed in the air flow path to regulate the flow of the ambient air.

### BRIEF DESCRIPTION OF THE DRAWINGS

The present invention and the objects and advantage thereof will become more obvious from the following description when taken in light with the accompanying drawings wherein like reference numerals denote like elements and in which:

FIG. 1 is an exploded perspective view of the device for collecting and analyzing fluid samples in accordance with the present invention generally showing a container and a cap, which comprises a base and a cover.

FIG. 2 is a perspective view of a base with valves.

FIG. 3 is a perspective view of a base with a testing system disposed in a testing chamber.

FIG. 4(a) is a perspective view of a valve.

FIG. 4(b) is a cross-sectional view of a valve, taken across line 2-2 of FIG. 4(a).

FIG. 5(a) is a cross-sectional view showing a flow control valve disposed inside a flow channel and rotated to an open position.

FIG. 5(b) is a cross-sectional view showing a flow control valve disposed inside a flow channel and rotated to a close position.

FIG. 6 is a cross-sectional view showing a vent control valve disposed inside an air flow path and rotated to an open position.

FIG. 7(a) is a bottom perspective view of a key.

FIG. 7(b) is a top perspective view of a key with a valve.

### DETAILED DESCRIPTION

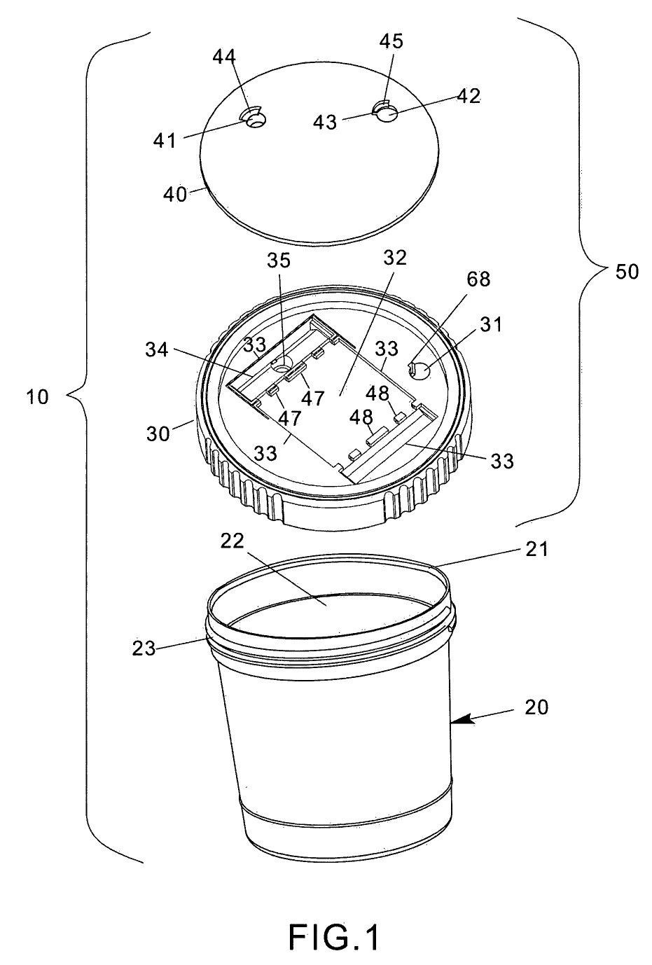

Turning to FIG. 1, an example of an assaying device 10 for collecting and analyzing body fluid samples, in accordance with the present invention, is shown. The device generally comprises a container 20 and a cap 50. The container 20 generally includes an opening 21 which provides a means for collecting the fluid samples in an interior space 22 of the container 20. Screw threads 23 are disposed in the container 20 proximate to the opening 21 for accepting the cap 50 and sealing the container 20. In the illustrated embodiment, the container 20 has a rotationally symmetric body, which may be formed from any suitable material, such as plastic.

The cap 50 comprises of a base 30 and a cover 40. The base 30 comprises an elongated air-vent opening 31 for enabling the ingress of ambient air into the container 20. The base 30 further comprises a testing chamber 32 for housing a testing system to assay the fluid samples. The testing chamber 32 comprises of a chamber rim 33 defining the test chamber 32. The testing chamber 32 further comprises a sloped plenum 34, or a depression, at a first end. An elongated opening 35 is disposed at the bottom of the plenum 34. When the cap 50 is engaged to the container 20, the elongated opening 35 defines a flow channel that communicates between the container 20 and the testing chamber 32 enabling the fluid samples to be deposited to the plenum 34 from the container 20.

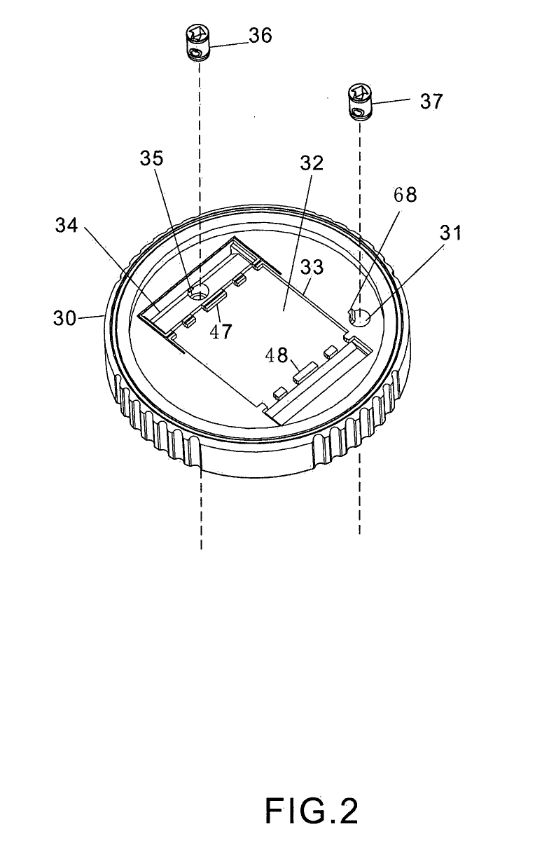

As hereinafter described in more detail, a regulator can be disposed in the flow channel to regulate the flow of the fluid samples. In the illustrated embodiment in FIG. 2, a flow control valve 36 can be disposed in the opening 35 as the regulator for regulating the flow of the fluid samples in the flow channel. The flow channel can be closed or opened by closing or opening the flow control valve 36 as hereinafter described in more detail. Also illustrated in FIG. 2, a vent control valve 37 can be disposed in the air-vent opening 31 for regulating the flow of ambient air into the container 20.

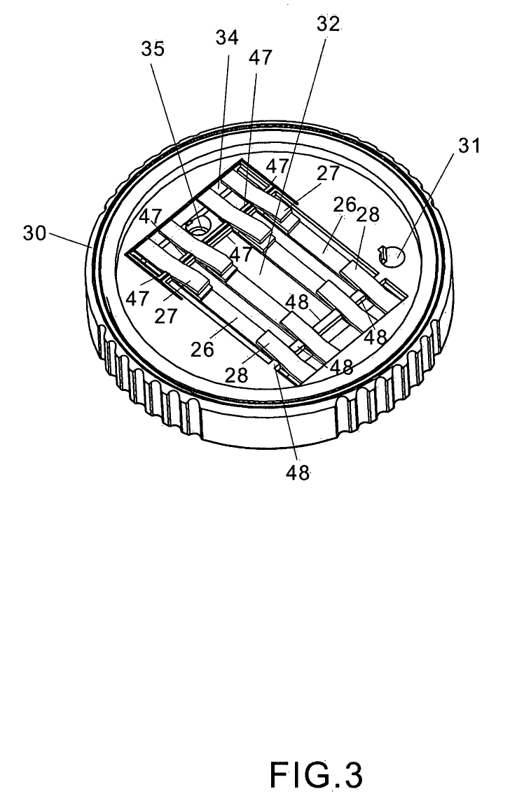

As shown in FIG. 3, a testing system can be disposed in the testing chamber 32 for assaying the fluid samples. As hereinafter described in more detail, when the device 10 is tilted toward the plenum 34, the fluid samples can be introduced from the container 20 to the plenum 34 through the flow channel as defined by the elongated opening 35, and the fluid samples deposited in the plenum 34 can be chemically or immunologically reacted with the testing system providing observable chromatographic results for indicating a presence or absence of detecting substances in the fluid samples.

Returning to FIG. 1, the cover 40 may be permanently fixed to the base 30 after the testing system is laid down in the testing chamber 32. The cover 40 may be formed from any suitable material, such as plastic, but preferably, the material is transparent for ease of observing the chromatographic test results. The means to fix the cover 40 to the base 30 are not described in detail herein, as such details are well known and are not considered a part of the present invention. A portion of the cover 40 overlaying the testing chamber 32 also defines a top wall of the testing chamber 32. Preferably, the cover 40 is sonically welded with the chamber rim 33 to provide a tight seal especially, between the plenum 34 and the cover 40.

The cover 40 further comprises a first opening 41 and a second opening 42, wherein the second opening 42 has a notch 43. When the cover 40 is fixed to the base 30, the positions of the first opening 41 and the second opening 42 align with the positions of the opening 35 and the air-vent opening 31 respectively, which are required for operating the flow control valves 36 and the vent control valve 37 (FIG. 2) after the cover 40 is fixed to the base 30.

Referring now to FIG. 3, generally, the testing system includes test strips 26, wick materials 27 for introducing the fluid samples to the test strips 26 and the wick materials 28 for facilitating permeation of the fluid samples in the test strips 26. In operation, the plenum 34 acts as a reservoir for the fluid samples to be tested. The fluid samples are first deposited in the plenum 34. The fluid samples deposited in the plenum 34 then becomes absorbed by the wick materials 27 and begin migrating through the test strips 26 by capillary action. The test strips 26 provide for chromatographical means for indicating a presence or absence of a specific detecting substance in the fluid samples. The functionality of the test strips and the assembly of the testing system are not described in detail herein, as such details are well known and are not considered a part of the present invention.

The testing chamber 32 further comprises a plurality lower limiting elements 47, which partially define the plenum 34, and a plurality upper limiting elements 48. The plurality test strips 26 may be separated from one another by disposing one end of the test strips 26 between the upper limiting elements 48 and the other ends between the lower limiting elements 47. While four test strips are shown, a greater or smaller number of individual strips may be utilized by increasing or decreasing the corresponding numbers of lower limiting elements 48 and upper limiting elements 47, thus any number of concurrent tests for detecting substances may be performed with the device of the present invention. Furthermore, when the fluid samples were deposited into the plenum 34, the lower limiting elements 47, in cooperation with the cover 40, prevents the escape of the fluid samples from the plenum 34 to the other parts of the testing chamber 32 except through the wick materials 27 and the test strips 26.

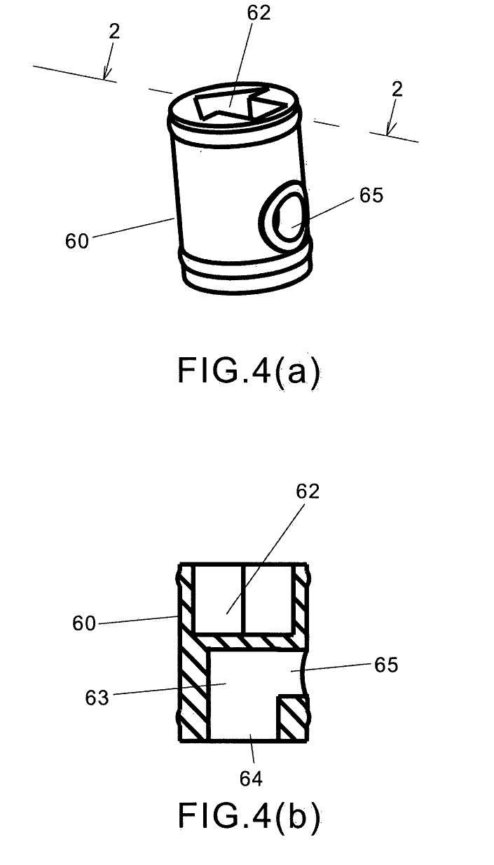

Same type of valve can be used for the flow control valve 36 and the vent control valve 37. FIG. 4(a) shows an embodiment of a valve 60 as used for the flow control valve 36 and the vent control valve 37. The valve 60 is preferably cylindrically shaped and can be rotated. As shown in FIG. 4(b), a cross-sectional view of the valve, the valve 60 comprises an actuating element 62 at a first end, and a right angled bore 63 having a first opening 64 at a first end and a second opening 65 at a second end.

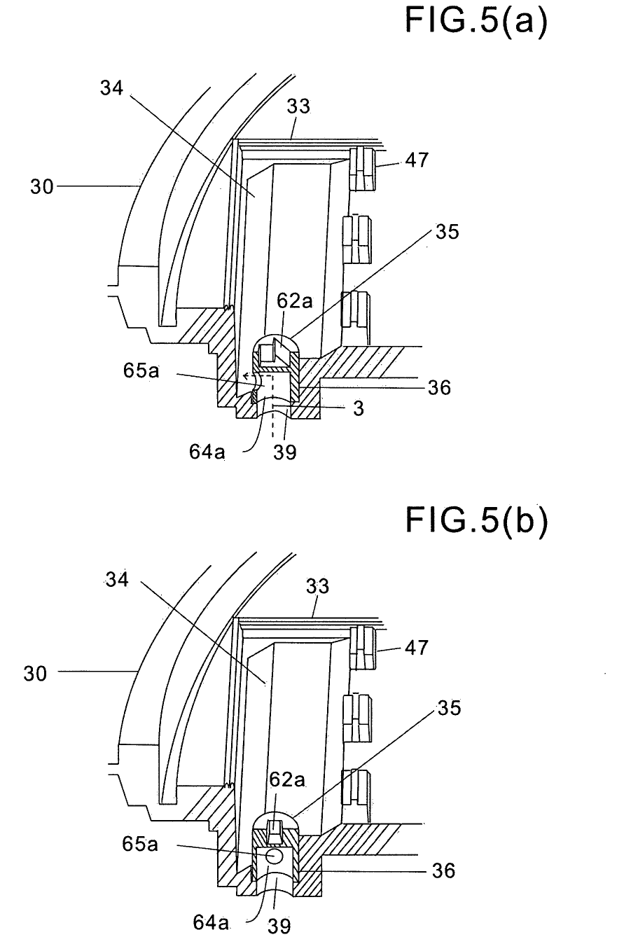

Referring now to FIG. 5(a), the opening 35 comprises a flange 39 at a first end that extends laterally inward for holding the flow control valve 36 inside the opening 35. When a same type of valve as the valve 60 is used for the flow control valve 36, the flow control valve 36 comprises a flow valve actuating element 62a and a first opening 64a and a second opening 65a. As the valve 36 is rotated to an open position, the second opening 65a faces the plenum 34 that establishes a flow path for the fluid samples to flow from the container 20, through the first opening 64a and then the second opening 65a, and into the plenum 34 as indicated by an arrow 3. As shown in FIG. 5(b), when the flow control valve 36 is rotated to a closed position, the second opening 65a is blocked by the inner wall of the elongated opening 35, thus preventing the flow of the fluid samples from the container 20 to the plenum 34.

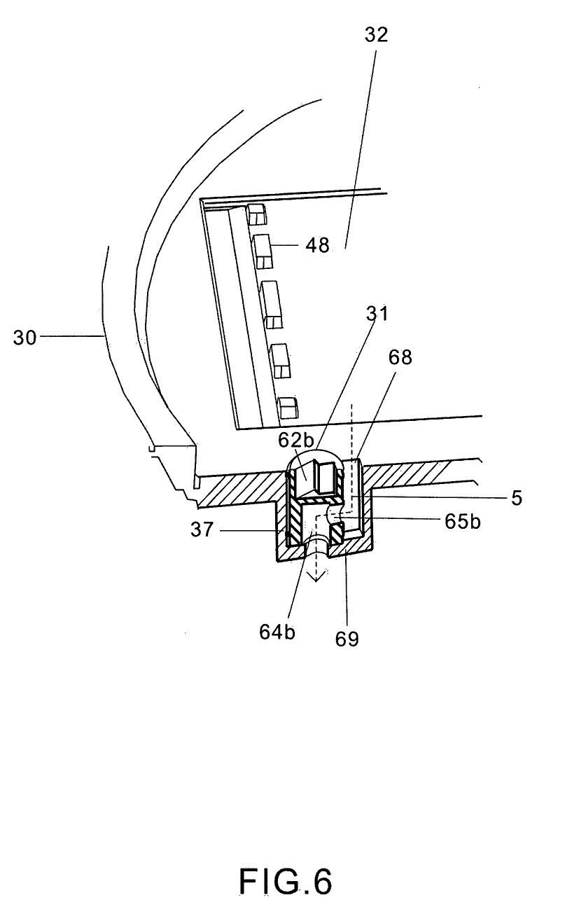

As shown in FIG. 6, the air-vent opening 31 comprises a flange 69 at a first end that extends laterally inward for holding a valve inside the air-vent opening 31. The air-vent opening 31 further comprises a notch 68 formed from the flange 69 to the top of the base 30 that partially defines an air flow path for ambient air flow into the container 20. As noted above, the same type of valve 60 can be used for the vent control valve 37. When a same type of valve as the valve 60 is used for the vent control valve 37, the vent control valve 37 comprises a vent valve actuating element 62b and a first opening 64b and a second opening 65b. As the valve 37 is rotated to an open position, the second opening 65b aligns with the notch 68 which establishes the air flow path enabling the ambient air to flow into the container 20 through the notch 68 and via the second opening 65b and the first opening 64b, as indicated by an arrow 5. When the valve 37 is rotated to a closed position, the second opening 65b misaligns with the notch 68 and faces the inner wall of the air-vent opening 31, and is blocked by the inner wall of the air-vent opening 31, thus preventing the flow of the ambient air to the container 20.

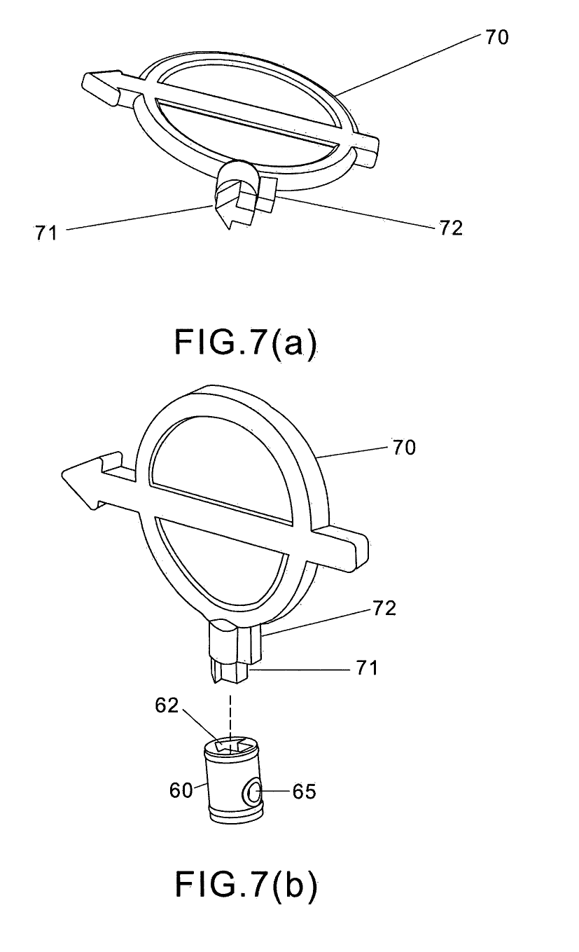

In the illustrated embodiment, the flow control valve 36 and the vent control valve 37 can be opened or closed by rotating the valves. The valves can be rotated by means of an actuation key. FIG. 7(a) shows an embodiment of the actuation key 70. The actuation key 70 comprises a projection element 71. The projection element 71 can be designed with the complementary shape of the depression of the actuating element 62 of the valve 60, and thereby, the key 70 can be engaged with the valve 60 by inserting the projection element 71 into the actuating element 62, as best illustrated in FIG. 7(b). The valve 60 then can be rotated by turning the key 70. When the same type of valve 60 is used for both the flow control valve 36 and the vent control valve 37, the flow control valve 36 and the vent control valve 37 can be rotated by using the key 70.

The key 70 further comprises a protruding heel 72 (FIG. 7(a)). Referring to FIG. 1, the first opening 41 and the second opening 42 further comprise depressions 44 and 45 respectively, which are shaped like an arc, or circular ring sections. When the key 70 is inserted in the flow control valve 36, the heel 72 will be automatically engaged, or inserted, into the depression 44, and likewise when the key 70 is inserted in the vent control valve 37, the heel 72 will be automatically engaged, or inserted, into the depression 45. Because the heel 72 can only move within the range of the arcing distance of the depression, the depression 44 or 45 thereby delimits the rotational range of the key 70. Delimiting the rotation of the key 70, in turn delimits the rotational ranges of the flow control valve 36 and the vent control valve 37. The placement and the arcing distance of the depression can be coordinated so that when the heel 72 is at one end of the depression, the valve assumes an open position and when at another end, the valve assumes a close position; thereby, it can assist a technician to accurately locate the open and close positions of the valves.

The operation of the present invention with the above embodiments is as follows: prior to collecting the fluid samples, the flow control valve 36 and the vent control valve 37 are closed. The closure of the flow control valve 36 seals the testing chamber 32 and prevents tampering with the testing system, such as by prematurely introducing the fluid samples into the testing chamber. After the fluid samples are collected in the container 20, the cap 50 is screwed tightly onto the container 20. The fluid samples then can be tested in the field immediately following the collection or stored in a suitable storage environment, such as a refrigerator, and tested later.

When desired to test the sample fluid, the flow control valve 36 and the vent control valve 37 are opened by inserting the actuating key 70 and rotating the valves to open positions. The device 10 is tilted toward the plenum 34 until the plenum 34 is filled with the fluid samples. When the plenum 34 is filled with the fluid samples, the flow control valve 36 and the vent control valve 37 are closed by rotating the valves with the actuating key 70 to the close position. The device 10 is then brought to its upright position.

The closure of the flow channel immediately after the fluid samples are deposited in the test chamber 32 provides an important function in that it prevents the backward flow of the fluid samples that may have already chemically or immunologically interacted with the reagents in the test strips 26. Prevention of the backflowing substantially eliminates the fluid samples that have interacted with the reagents from contaminating the remaining fluid samples in the container 20. In so doing, it preserves the integrity of the fluid samples remaining in the container 20 for any further testing.

The test begins to run automatically as the sample fluids migrate through the wick materials 27 and permeate through the test strips 26. The technician can observe the chromatograph test results on the test strips 26 through the cover 40. If any of the results are positive, the remaining fluid samples in the container can be sent to a certified laboratory for further testing.

Although there has been hereinabove described an assaying device in accordance with the present invention, for the purpose of illustrating the manner in which the invention may be used to advantage, it should be appreciated that the invention is not limited thereto. Accordingly, any and all modifications, variations, or equivalent arrangements which may occur to those skilled in art, should be considered to be within the scope of the present invention as defined in the appended claims.

What is claimed is:

1. A device for collecting and analyzing fluid samples comprising:
a container for collecting and storing fluid samples;
a cap for sealing the container;
a testing system disposed in the cap for chemically or immunologically analyzing the fluid samples;
a flow channel disposed in the cap for communicating between the container and the testing system and enabling the fluid samples to be introduced to the testing system from the container upon a change of orientation of the device;
a flow control valve disposed in the flow channel for regulating the flow of the fluid samples in the flow channel;
an air flow path disposed in the cap for enabling flow of ambient air into the container to equalize any negative pressure that was formed in the container by the cooling of the collected fluid samples and that may interfere with the flow of the fluid samples from the container into the testing system;
a vent control valve disposed in the air flow path for regulating the flow of ambient air into the container; and
a key for controlling the flow control valve and the vent control valve,
thereby the key can open the flow control valve and the vent control valve to allow the fluid samples to flow from the container into the testing system, through the flow channel, or the key can close the flow control valve and seal the flow channel to prevent the fluid samples from flowing into or out of the testing system.

2. A device according to claim 1, wherein the flow control valve comprises of a flow valve actuating element designed in a form of a depression for receiving the key.

3. A device according to claim 2, wherein the flow control valve further comprises of a right angled bore for flowing of the fluid samples.

4. A device according to claim 3, wherein the vent control valve comprises a vent valve actuating element designed in the identical form of a depression as the flow valve actuating element for receiving the key,

5. A device according to claim 4, wherein the vent control valve further comprises a right angled bore for flowing of ambient air.

6. A device according to claim 5, wherein the flow control valve is cylindrically shaped and can be rotated.

7. A device according to claim 6, wherein the vent control valve is cylindrically shaped and can be rotated.

8. A device according to claim 7, wherein the key comprises a projection element which is in a complementary shape of the depressions of the flow valve actuating element and the vent valve actuating element for enabling the key to engage in the flow control valve or the vent control valve and rotate the valves.

9. A device according to claim 8, wherein the cap comprises a testing chamber for housing the testing system.

10. A device according to claim 9, wherein the testing system is disposed in the testing chamber.

11. A device according to claim 10, wherein the testing chamber comprises a plenum for providing a reservoir for the fluid samples that are introduced into the testing chamber.

12. A device according to claim 11, wherein the cap further comprises a cover for partially providing a top wall for the test chamber.

13. A device according to claim 12, wherein the cover comprises a first opening for enabling a key to access the flow control valve and a second opening for enabling the key to access the vent control valve.

14. A device according to claim 13, wherein the second opening comprises a notch for enabling the ambient air to flow into the air flow path.
